(19) United States
(12) Patent Application Publication
(10) Pub. No.: US 2026/0371445 A1
(43) Pub. Date: Nov. 19, 2026

(54) Non-Fluorinated Hybrid Sol-Gel/Silicone Resin Coating

(71) Applicant: SEB S.A., Ecully (FR)

(72) Inventors: Stéphanie Le Bris, Ecully Cedex (FR); Perrine Tanguy, Ecully Cedex (FR)

(73) Assignee: SEB S.A., Ecully (FR)

(21) Appl. No.: 18/998,855

(22) PCT Filed: Jul. 28, 2023
(86) PCT No.: PCT/FR2023/051209

§ 371 Date: Jan. 27, 2025

(30) Foreign Application Priority Data
Jul. 29, 2022 (FR) FR2207873

(51) Int. Cl. H05B 3/02; A47J 36/02; C08K 3/16; C08K 3/22; C09D 7/61; C09D 183/06

(52) U.S. Cl. CPC H05B 3/02; A47J 36/025; C08K 3/22; C09D 7/61; C09D 183/06; C08K 3/16; C08K 2003/2206; C08K 2003/221; C08K 2003/2213; C08K 2003/2258; C08K 2003/2272

(57) ABSTRACT

A cooking utensil or electrical cooking appliance includes a metal substrate coated on at least one face with at least the following layers and in this order proceeding from the metal substrate: a base layer having one or more sol-gel compositions, one or more intermediate layers including of one or more coloring agents and optionally one or more silicone resins, and/or one or more thermoplastic polymers, and/or one or more fillers, and/or one or more additives, a finishing layer that is to come in contact with food during cooking and includes one or more silicone resins and optionally one or more thermoplastic polymers, and/or one or more fillers, and/or one or more additives, and/or flakes.

The field of the invention is that of culinary items coated on one of their faces with a coating and more precisely, silicone resin-based coatings of these items.

In the field of culinary items, coatings based on fluoropolymers and, in particular, polytetrafluoroethylene (PTFE) are known to the general public for their non-stick and temperature resistance properties.

However, these coatings have a low mechanical strength.

Application WO 2020/144051 concerns a coating based on fluoropolymers whose mechanical resistance to abrasion is improved by the integration of organic (SiC) and mineral (Al₂O₃) fillers into the primer and finishing layers of the coating.

The performance gain achieved with regard to mechanical strength is satisfactory but still not optimal.

Coatings with a hard base layer coated with a sol-gel coating, such as especially described in patents EP 2334444 and EP 2334445, are also known to improve the resistance to mechanical impacts. However, such coatings do not allow sufficiently precise temperature control.

Fluoropolymer-based coatings are intended, in the first place, for frying pans and saucepans, but other applications can be envisaged in the field of molding (molds, cake dishes, waffle makers, etc.) or small domestic equipment (rice cookers, fryer inserts, electric crepe makers) because of their stampability.

An alternative to PTFE coatings is to use so-called “ceramic” coatings, developed via a sol-gel method and the use of tetraethyl orthosilicate (EP 2806776 B1). These coatings have the specific feature of being hard and resistant to mechanical wear but have a brittle behavior and are less non-stick compared to coatings based on fluoropolymers.

In addition, these coatings are not well suited to molding and small domestic equipment because of their lack of stampability.

In the field of molding (consumer or industrial), fluoropolymer-based coatings are not as widespread because the temperature resistance constraints are lower (max 220 °C) and allow the use of other types of coatings, such as silicone.

Pure silicone resins are described as non-stick and resistant to temperatures above 220-230 °C. In return, they are considered to have poor adherence to the substrate.

Conversely, silicone-polyester resins are very widespread in the molding industry because they are non-stick while being adherent to the substrate and compatible with stamping processes. However, they degrade at temperatures above 230 °C. In fact, the temperature range of use for culinary items is between 5° and 250 °C and it is not unusual to reach temperatures of 300 °C or even 350 °C in the case of items with induction bottoms. Their use is therefore not compatible with the temperatures of use in the field of culinary items.

However, the control of the cooking temperature is an essential parameter because it is necessary for successful cooking and ensures the preservation of the physicochemical properties of non-stick coatings.

In light of this, cooking start temperature indicators have been developed for consumers. The aim is to indicate by a color change the temperature at which consumers can start cooking and thus avoid any possible overheating of the food.

This technology is generally based on the use of thermochromic pigments whose color changes between room temperature and 250° C. depending on the nature of the material.

Examples of implementation in sol-gel coatings are given in application FR 3110590. It will be noted that the sol-gel coating of this application does not comprise silicone resin.

In addition to thermochromic pigments, other visual differentiators can be added to coatings (EP 2675328 A1, EP 2412846 B1).

Patent EP 2319631 describes the development of a two-layer coating based on silicone resin coupled with a high temperature thermoplastic material between 0.5 and 20% (base layer) making it possible to obtain a coating that is mechanically resistant, adherent to the substrate and non-stick. The nature of the thermoplastic varies between the base layer (PEEK) and the finishing layer (PPS) and it is mainly located in the base layer to ensure adhesion to the substrate. This patent does not describe a temperature indicator.

Patent US 2022/0073785 proposes a two-layer silicone/thermoplastic coating architecture that is much more concentrated in thermoplastic material and also does not describe the integration of a colored indicator based on thermochromic pigments.

Thus, there is a need for improved culinary items, especially allowing better control, in particular visual control, of the cooking of food, while guaranteeing good mechanical strength, good thermal resistance, simple and flexible implementation—for example in terms of the variety of reagents that can be used—at reasonable industrial costs.

### SUMMARY OF THE INVENTION

A first object of the invention concerns a coated cooking element (1) for a culinary item or electric cooking appliance, comprising a metal substrate (2) coated on at least one face (2a) with at least the following layers and in this order starting from the metal substrate (2):
(3a) a base layer comprising one or more sol-gel compositions;
(3b) one or more intermediate layers composed of one or more coloring agents; and, optionally:
   one or more silicone resins; and/or
   one or more thermoplastic polymers; and/or
   one or more fillers; and/or
   one or more additives.
(3c) a finishing layer intended to come into contact with food during cooking composed of one or more silicone resin(s) and, optionally:
   one or more thermoplastic polymers; and/or
   one or more fillers; and/or
   one or more additives; and/or
   flakes.

Another object of the invention concerns a method of manufacturing a coated cooking element (1) according to the invention, comprising the following successive steps:
i. supplying a metal substrate comprising at least one face to be coated;
ii. optionally, pre-treating the face of said metal substrate intended to be coated;
iii. applying a sol-gel base layer on the face to be coated;
iv. optionally, drying and/or curing of the base layer;
v. applying at least one intermediate layer (3b);
vi. optionally, drying of the intermediate layer(s) (3b);
v. applying at least one finishing layer (3c); and
viii. curing of all the base (3a), intermediate (3b) and finishing (3c) layers.

Another object of the invention concerns a culinary item comprising a coated cooking element according to the invention.

Another object of the invention concerns an electric cooking appliance having a coated cooking element and a heating source configured to heat said coated cooking element, characterized in that said coated cooking element is according to the invention.

The present invention has at least one of the following advantages:
the coating according to the invention has a thermochromic functionality with clear visibility, a contrasting color change over a targeted and centered temperature range, for example around the cooking temperatures of food for a cooking appliance;
the coating according to the invention can provide good temperature control during cooking of food, which is necessary for health and taste reasons, but also for safety and to limit point overheating that weakens the coating;
the thermochromic properties of the thermochromic pigment composition are reversible, meaning that after a color change under the effect of heat, the compound returns to its initial state and its initial color when the temperature decreases; this color change cycle (reversibility) can be repeated infinitely;
the coating according to the invention has a high thermal stability during temperature increases; it is stable up to approximately 450 °C;
the coating according to the invention has an enhanced mechanical strength due to the presence of a sol-gel base layer compared to a coating comprising silicone layers only;
the manufacturing method of the coating of the invention requires lower curing temperatures than for a coating comprising fluorinated resins of the PTFE type, which improves the environmental impact of the coating of the invention and the energy efficiency of its manufacturing method.

### DEFINITIONS

The term “layer” should be understood to mean, for the purposes of the present invention, a continuous or discontinuous layer. A continuous layer (also called a monolithic layer) is a single whole forming a total solid block completely covering the surface on which it is laid. A discontinuous layer (or non-monolithic layer) may comprise several parts, thus is not a single whole.

The term “base layer”, “primary layer”, “bonding layer” or “bonding primer” is understood to mean all the layers of the first layer applied directly to the substrate (it is preferable that this layer adheres well to the substrate and imparts all its mechanical properties to the coating: hardness, scratch resistance) to the last layer before the first decorative layer.

The term “finishing layer” or “finish” is understood to mean a continuous and transparent surface layer, this layer leaving the decorative layer perfectly visible while protecting it from mechanical damage and conferring its non-stick properties to the coating. Preferably, the last finishing layer is intended to be in contact with the food.

The term “decoration” or “decorative layer” is understood to mean one or more continuous or discontinuous layers comprising a pigment composition. The decoration can be in the form of one or more patterns and one or more colors. A decoration is clearly visible to the user with the naked eye and at a conventional distance for the use of the household item.

The term “overlapping layers” is understood to mean partially or completely superposed layers. These layers may be in the form of partially overlapping patterns, for example concentric discs.

The term “adjacent layers” is understood to mean layers that are not superposed. These layers may be in the form of identical or different non-superposed patterns, preferably uniformly distributed.

For the purposes of the present invention, the term “sol-gel composition” is understood to mean a composition synthesized by a sol-gel route from a solution based on precursors in the liquid phase, which is transformed into a solid by a set of chemical reactions (hydrolysis and condensation), at low temperature. The composition thus obtained may be either organo-mineral or entirely mineral.

For the purposes of the present invention, the term “organo-mineral composition” is intended to mean a composition whose network is essentially inorganic, but which comprises organic groups, especially because of the precursors used and the curing temperature of the coating. Such a composition is generally obtained by a sol-gel process.

For the purposes of the present invention, the term “wholly mineral composition” is understood to mean a composition composed of an entirely inorganic material, free of any organic group. Such a composition is generally obtained by a sol-gel route with a curing temperature of at least 400 °C, or from precursors of the tetraethoxysilane (TEOS) type with a curing temperature that may be less than 400 °C.

The term “reference temperature pigmentary composition” is understood to mean a composition comprising a pigment which, at a given temperature, indicates to the user that the optimal use temperature has been reached. This indication is made by comparison of the colors of the thermochromic pigment composition and of the reference temperature pigmentary composition. Either the optimal use temperature is reached when the colors are identical or the optimal use temperature is reached when the colors are visually very different.

The “reference temperature pigmentary composition” may include a pigment that has:
the same color as the thermochromic pigment composition, at the optimal temperature of use,
either because this pigment has at room temperature the same color as the thermochromic pigment composition at the optimal temperature of use, and does not change color with temperature,
or because this pigment has a color different from that of the thermochromic pigment composition at room temperature, which changes to the same color as the thermochromic pigment composition at the optimal temperature of use,
a color very different from that of the thermochromic pigment composition at the optimal temperature of use, whether this pigment changes color or not with the temperature change.

The optimal temperature of use can be achieved when the color of the reference temperature pigmentary composition corresponds to a color indicated in the user guide of the household item comprising the coating of the invention or to a color indicated on a color scale provided to the user with the item.

The reference temperature pigmentary composition may be, for example, a cooking reference temperature pigmentary composition or an indication of the risk of overheating. The reference temperature pigmentary composition is thermochromic or thermostable.

The expression “thermochromic semiconductor” should be understood to mean, for the purposes of the present invention, an inorganic or organic compound, which exhibits a reversible change in coloration upon an increase in temperature. The progressive and reversible thermochromic nature of these semiconductor compounds is linked to the reduction of the bandgap width of the semiconductor because of the expansion of the material. Indeed, the periodicity of the network of anions and cations leads to the gathering of energy levels into energy bands. The energy band filled with higher energy is called the valence band and the empty energy band of lower energy is called the conduction band. Between these two bands, there is a forbidden band called a gap. The color of a semiconductor material can come from the presence of a charge transfer that corresponds to the passage of an electron either from a valence band to a conduction band on the same atom, or, commonly, from the orbital of an anion to the orbital of a cation (interatomic photon absorption).

In the fields of application envisaged for the present invention, the optimal conditions are reached when the coating reaches a temperature suitable for cooking food, preferably between 10° and 250 °C.

For the purposes of the present invention “thermochromic pigment or pigmentary composition” should be understood to mean a pigment or pigment composition that changes color as a function of temperature in a given temperature range, this change being reversible. This color change is visible to the user with the naked eye and at a conventional distance for use.

The term “thermostable pigment” is understood to mean a pigment which does not show a color change when subjected to a temperature increase in a given temperature range or which shows a color change when subjected to a temperature increase in a given temperature range so low that it is not visible to the user with the naked eye and at a conventional distance for use.

Preferably, thermostable pigments have a color difference ΔE* between 25 °C and 200 °C of less than 10, ΔE* being defined by the CIE1976 formula in the CIELAB color space:

ΔE*=\sqrt{(L₂*−L₁*)²+(a₂*-a₁*)²+(b₂*−b₁*)²}

L₁*, a₁* and b₁* characterizing the L*a*b values of said compound at room temperature L₂*, a₂* and b₂* characterizing the L*a*b values of said compound at 200 °C.

The expression “the colors are identical” shall mean that they are indistinguishable by the user with the naked eye and at a conventional distance for use.

“Coating” is understood to mean all the layers covering the metal substrate and adhering to this substrate.

“Silicone resin-based coating” is understood to mean a coating that comprises one or more silicone resins in one or more of its layers. The coating according to the invention obtained is advantageously solid. “Solid” is understood to mean the characteristic of a cohesive material insoluble in water, in the usual solvents, in food components such as aqueous or fatty mixtures, even if the material may be very hard or very flexible, such as an elastomer.

For the purposes of the present invention, the expression “culinary item” should be understood to mean an object intended for cooking. For this purpose, it is intended to receive a heat treatment. The culinary item thus comprises an “inner face” or “cooking face”, the coating of which is intended to be brought into contact with food during cooking.

The expression “object intended to receive a heat treatment” should be understood to mean, for the purposes of the present invention, an object that will be heated by an external heating system such as frying pans, saucepans, sauté pans, woks and barbecue grills and which is capable of transmitting the heat energy supplied by this external heating system to a material or food in contact with said object.

The expression “electric cooking appliance” should be understood to mean, for the purposes of the present invention, a heating object possessing its own heating system, such as an electric crepe maker, an electric raclette appliance, an electric fondue appliance, an electric grill, an electric griddle, an electric cooker, a bread maker and an electric pressure cooker.

In the present invention, the % by weight values are expressed as dry weight, i.e., without solvent.

### FIGURES

FIG. 1: Diagram of a cooking element according to the invention whose layer (3b) is continuous and covers the entire layer (3a)

FIG. 2: Diagram of a cooking element according to the invention whose layer (3b) does not cover the entire layer (3a) and forms a decoration

FIG. 3: Diagram of a cooking element according to the invention whose layer (3b) consists of two decorations (i) and (j)

FIG. 4: Pattern distribution diagram. 4A=adjacent non-overlapping patterns. 4B=partially overlapping patterns. 4C=overlapping patterns.

FIG. 5: Diagram of a culinary item according to the invention

FIG. 6: Diagram of an electric cooking appliance according to the invention

### DETAILED DESCRIPTION OF THE INVENTION

The invention concerns a coated cooking element (1) for a culinary item or electric cooking appliance, comprising a metal substrate (2) coated on at least one face (2a) with at least the following layers and in this order starting from the metal substrate (2):
(3a) a base layer comprising one or more sol-gel compositions;
(3b) one or more intermediate layers composed of one or more coloring agents; and, optionally
   one or more silicone resins; and/or
   one or more thermoplastic polymers; and/or
   one or more fillers; and/or
   one or more additives.
(3c) a finishing layer intended to come into contact with food during cooking composed of one or more silicone resin(s); and
   one or more thermoplastic polymers; and/or
   one or more fillers; and/or
   one or more additives; and/or
   flakes.

Advantageously, the layers (3a), (3b) and (3c) form a coating (3) which coats the metal substrate (2). This coating (3) has non-stick properties and forms a non-stick coating.

Advantageously, the layer (3a) is in contact via one of its faces with the metal substrate (2) via its face (2a).

The at least one coated face (2a) of the metal substrate is therefore a cooking surface. In other words, the coating of the cooking element (1) according to the invention is intended to be in contact with food.

Advantageously, the finishing layer (3c) is in contact via one of its faces with food and thus forms a cooking surface (5).

The coating of the cooking element (1) according to the invention does not comprise a fluoropolymer. In other words, said coating is devoid of fluoropolymers.

Advantageously, the thickness of the layer (3a) is comprised between 5 μm and 100 μm, preferably between 8 μm 70 μm, more preferentially between 20 and 70 μm, particularly preferably between 10 μm and 30 μm.

Advantageously, the thickness of the layer (3b) is comprised between 1 μm and 100 μm, preferably between 2 μm and 30 μm, particularly preferably between 3 μm and 10 μm.

Advantageously, the thickness of the layer (3c) is comprised between 0.05 μm and 100 μm, preferably between 0.08 μm and 20 μm, particularly preferably between 0.1 μm and 10 μm.

According to one embodiment, the thickness of the layer (3c) is comprised between 0.1 μm and 2 μm, preferably between 0.2 μm and 1.5 μm.

According to another embodiment, the thickness of the layer (3c) is comprised between 10 μm and 100 μm, preferably between 20 μm and 85 μm, particularly preferably between 30 μm and 70 μm.

According to a particular embodiment:
the thickness of the layers (3a) is comprised between 5 μm and 100 μm, typically between 20 μm and 70; and
the thickness of the layer (3b) is comprised between 1 μm and 100 μm, typically between 2 μm and 30 μm;
the thickness of the layer (3c) is comprised between 0.05 μm and 100 μm, preferably between 0.08 μm and 20 μm.

The coating of the cooking element (1) according to the invention may comprise one or more layers (3ab), optionally interposed between the layer(s) (3a) and the layer(s) (3b) or between the layer(s) (3a) and the layer(s) (3c) composed of one or more silicone resins and, optionally:
one or more thermoplastic polymers; and/or
one or more fillers; and/or
one or more additives.

Advantageously, the thickness of the layer(s) (3ab) is comprised between 0.05 μm and 100 μm, preferably between 0.08 μm and 20 μm, particularly preferably between 0.1 μm and 10 μm.

### Metal Substrate

Advantageously, said metal substrate (2) is a substrate made of aluminum, stainless steel, cast iron or cast aluminum, iron, titanium or copper.

For the purposes of the present invention, aluminum is understood to mean a metal composed of 100% aluminum or an aluminum alloy.

Advantageously, the metal substrate (2) is an aluminum substrate, stainless steel substrate or a multilayer metal substrate. The metal substrate (2) may be a two-layer or three-layer substrate, these multilayer(s) being obtainable, for example, by co-lamination, by solid state bonding, or by hot or cold impact bonding.

Preferably, the metal substrate (2) comprises alternating layers of metal and/or metal alloy.

According to one embodiment, the metal substrate (2) is an aluminum alloy substrate, stainless steel substrate, or a multilayer metal substrate having an aluminum alloy or stainless-steel face (2a).

Preferably, the metal substrate (2) is an aluminum substrate.

Advantageously, the thickness of the metal substrate (2) is comprised between 0.5 mm and 10 mm.

Advantageously, the face (2a) of the metal substrate (2) has previously undergone a surface treatment making it possible to improve the adhesion of the coating to said substrate.

According to one embodiment, the surface of the face (2a) of the metal substrate (2) has undergone a surface treatment, said surface treatment being chemical etching, brushing, hydration, sandblasting, shot blasting, physicochemical treatment of the plasma or corona or laser type, chemical activation or a combination of these different techniques.

Advantageously, the face (2a) of the substrate to which the coating (3) according to the invention will be applied can be treated so as to increase its specific surface; for an aluminum substrate, this treatment can be carried out by anodizing (creation of a tubular alumina structure), by chemical etching, by sandblasting, by brushing, by shot blasting or by adding material by means of a technology such as thermal spraying (flame, plasma or arc spraying). The other metal substrates can also be polished, sandblasted, brushed, microbead-blasted or receive added material by means of a technology such as thermal spraying (flame, plasma or arc spraying).

Metal substrates that can be used in the present invention advantageously include anodized or non-anodized aluminum substrates, optionally polished, brushed, sandblasted, shot-blasted or microbead-blasted, anodized or non-anodized aluminum alloy substrates, optionally polished, brushed, sandblasted or micro-bead blasted, steel substrates, optionally polished, brushed, sandblasted, shot-blasted or microbead-blasted, stainless steel substrates, optionally polished, brushed, sandblasted or microbead-blasted, cast steel, aluminum or iron substrates, copper substrates, optionally hammered or polished.

Advantageously, the substrate may be chosen from substrates comprising ferritic stainless steel/aluminum/austenitic stainless steel layers, substrates comprising stainless steel/aluminum/copper/aluminum/austenitic stainless steel layers, shells made of cast aluminum, aluminum or aluminum alloys lined with an outer stainless steel bottom, metal co-laminated substrates, for example two-layer co-laminated substrates comprising a stainless steel layer (for example intended to constitute the inner face of the item) and an anodized or non-anodized layer of aluminum or aluminum alloy, intended to constitute the outer face of the item).

Advantageously, the arithmetic mean roughness Ra of the surface of the face (2a) of the metal substrate (2) is greater than or equal to 1 μm.

The arithmetic mean roughness Ra is measured using a roughness meter according to ISO 4287. Ra represents the arithmetic mean of the deviations from the mean. The surface topography can be studied, in particular, using a profilometer with a probe provided with a fine stylus equipped with a diamond tip, or with an optical metrology apparatus like Altisurf®, in which a confocal chromatic sensor allows a contactless measurement. The study of this surface topography makes it possible to define the mean arithmetic roughness Ra.

### Sol-Gel Compositions

The sol-gel composition, also called SG composition, is an organo-mineral or entirely mineral sol-gel composition. These compositions synthesized by sol-gel route from precursors of the metal polyalkoxylate type preferentially have a hybrid network, generally of silica with grafted alkyl groups. A sol-gel (SG) composition is generally obtained from a sol-gel (SG) mixture comprising at least one colloidal metal oxide and at least one precursor of the metal alkoxide type.

The metal oxide is preferably a colloidal metal oxide chosen from colloidal silica and/or colloidal alumina.

Preferably a metal alkoxide is used chosen from the group composed of:
precursors corresponding to the general formula M₁ (OR₁)ₙ;
precursors corresponding to the general formula M₂ (OR₂)₍ₙ₋₁₎R₂′; and
precursors corresponding to the general formula M₃ (OR₃)₍ₙ₋₂₎R_{3′2}, with:
R₁, R₂, R₃ or R₃′ designating an alkyl group;
R₂′ designating an alkyl or phenyl group;
n being an integer corresponding to the maximum valence of the metals M₁, M₂ or M₃; M₁, M₂ or M₃ designating a metal chosen from Si, Zr, Ti, Sn, Al, Ce, V, Nb, Hf, Mg or Ln.

Advantageously, the metal alkoxide of the SG mixture is an alkoxysilane.

Alkoxysilanes which can be used in the SG mixture of the method of the invention especially include methyltrimethoxysilane (MTMS), tetraethoxysilane (TEOS), methyltriethoxysilane (MTES), dimethyldimethoxysilane, and mixtures thereof.

Preferably, the alkoxysilanes MTES and TEOS will be used, since they have the advantage of not containing methoxy groups. Indeed, methoxy hydrolysis leads to the formation of methanol in the sol-gel formulation, which, given its toxic classification, requires additional precautions during application. On the contrary, the hydrolysis of ethoxy groups generates only ethanol with a more favorable classification and therefore less restrictive use requirements for sol-gel coating.

The formation of this SG composition consists of mixing an aqueous composition A comprising the colloidal metal oxide and a solution B comprising the metal alkoxide. The mixing is advantageously carried out in a ratio of 40 to 75% by weight of the aqueous composition with regard to the weight of the sol-gel composition (A+B), such that the quantity of colloidal metal oxide represents 5 to 50% by weight of the sol-gel composition (A+B) in the dry state.

The aqueous composition A may also comprise a solvent, in particular a solvent comprising at least one alcohol. A solvent comprising at least one alcohol is referred to hereinafter as “alcoholic solvent”.

An alcohol is preferably a C₁-C₆ alcohol. A C₁-C₆ alcohol means a saturated, linear or branched, hydrocarbon chain having 1 to 6 carbon atoms and comprising a hydroxy group (—OH) attached to a carbon atom. Examples include ethanol, n-propanol and isopropanol.

The aqueous composition A may also comprise at least one silicone resin, especially as defined below.

The aqueous composition A may also comprise a pigment, especially as defined below.

The aqueous composition A may also comprise a mineral filler, especially as defined below.

The aqueous composition A may also comprise pyrogenic silica, the function of which is to regulate the viscosity of the sol-gel composition and/or the gloss of the dry coating.

The aqueous composition A typically comprises:
i) 5 to 50% by weight, with regard to the total weight of the aqueous composition A, of at least one colloidal metal oxide;
ii) 0 to 20% by weight, with regard to the weight of composition A, of a solvent comprising at least one alcohol;
iii) optionally 0.05 to 3% by weight with regard to the total weight of said aqueous composition A of at least one silicone oil;
iv) 5 to 30% pigment;
v) 2 to 30% mineral filler.

Solution B may further comprise a Bronsted or Lewis acid. Advantageously, the precursor of metal alkoxide type of solution B is mixed with an organic, mineral Lewis acid which represents 0.01 to 10% by weight of the total weight of solution B.

Particular examples of acids that can be used for mixing with the metal alkoxide precursor are acetic acid, citric acid, ethyl acetoacetate, hydrochloric acid or formic acid.

Solution B may also comprise a solvent, in particular a solvent comprising at least one alcohol.

Solution B may also comprise at least one silicone resin, especially as defined below.

Solution B may also comprise flakes, preferably metal flakes, especially as defined below.

According to an advantageous embodiment of the method of the invention, solution B may comprise a mixture of one of the alkoxysilanes as defined above and an aluminum alcoholate.

According to a preferred embodiment, the sol-gel composition is synthesized by a sol-gel route from a sol-gel mixture comprising or composed of a precursor of the metal alkoxide type, and, optionally:
a colloidal metal oxide precursor;
a solvent, preferably alcoholic;
a Bronsted or Lewis acid, preferably an acid chosen from acetic acid, citric acid, ethyl acetoacetate, hydrochloric acid or formic acid; and
additives chosen from at least one silicone resin, at least one pigment, at least one advantageously mineral filler, flakes, especially metal flakes, pyrogenic silica, or a mixture thereof;
or a mixture thereof.

Thus, the SG composition is preferentially mineral or organomineral, and may comprise at least one silicone resin, at least one pigment, at least one advantageously mineral filler, flakes, especially metal flakes, pyrogenic silica, or a mixture thereof. The SG composition may also comprise a solvent, in particular alcoholic, especially in the form of traces, and/or an acid, preferably an acid chosen from acetic acid, citric acid, ethyl acetoacetate, hydrochloric acid or formic acid.

### Silicone Resins

In the text of the description, the expression “silicone resin” is used interchangeably to denote silicone before or after its crosslinking. In the text of the description, the expression “silicone” designates an organopolysiloxane material. Crosslinking is the step that converts silicone into an insoluble material, for example by polyaddition, polycondensation or dehydrogenation. The crosslinking is carried out using precursors that are generally silicone oils or resins, which crosslink in order to obtain a three-dimensional network forming a material called silicone resin in the description.

This crosslinking can be done by thermal activation, or chemical activation using a catalyst, such as, for example, platinum.

The silicone resins may be obtained from precursors, advantageously soluble in a solvent or in emulsion in water, such as crosslinkable oils or resins, especially chosen from: a silicone hydride, a silicone oil resin comprising at least one vinyl group (—CH═CH₂), a silicone resin or silicone-polyester resin (copolymer) comprising at least one alkoxy group, for example methoxy or ethoxy, and/or a silicone or silicone-polyester resin (copolymer) comprising at least one alkoxy group, in particular ethoxy, or a hydroxy group, and mixtures thereof. These precursors have the ability to crosslink in order to obtain a silicone resin that is characterized by its insolubility and its substantially solid form.

Advantageously, these precursors are polymeric or oligomeric, either in the form of silicone oils of variable degree of branching, or in the form of silicone resins of variable degree of pre-crosslinking or copolymers of silicone resins such as silicone-polyester, silicone-alkyds, silicone-polyurethanes or silicone-epoxy resins, or in the form of a mixture of silicone oils, silicone resins and copolymers of silicone resins. The silicon atoms may be substituted by alkyl (in particular methyl) or aryl (in particular phenyl) groups or mixtures thereof. The oils or resins preferably contain one or more (2, 3 or more) hydroxy or alkoxy functional groups (in particular methoxy, ethoxy, butoxy) as substituents of silicon atoms.

Advantageously, the silicone resin(s) obtained after crosslinking of their precursors, i.e. crosslinked, is (are) chosen from the group composed of methyl silicone resins and/or phenyl silicone resins and/or methyl phenyl silicone resins, methyl silicone-polyester resin (copolymers), phenyl silicone-polyester resin (copolymers), methyl phenyl silicone-polyester resin (copolymers), silicone-alkyd resin (copolymers), modified silicone resin and mixtures thereof.

Advantageously, the silicone resin(s) is (are) chosen from the group composed of methyl silicone resins and/or phenyl silicone resins and/or methyl phenyl silicone resins, methyl silicone-polyester resin (copolymers), phenyl silicone-polyester resin (copolymers), methyl phenyl silicone-polyester resin (copolymers), silicone-alkyd resin (copolymers), modified silicone resin and mixtures thereof.

The silicone resins may be obtained from precursors, especially chosen from: a silicone hydride, a silicone resin comprising at least one vinyl group (—CH═CH₂), a silicone-polyester resin (copolymer) comprising at least one methoxy group, and/or a silicone-polyester resin (copolymer) comprising at least one ethoxy group, and mixtures thereof.

The silicone resin of the single layer (3) forms a network which may be composed of a combination of 4 simple organosiloxane units denoted M, D, T and Q depending on the degree of substitution by oxygen of the silicon atom, as described in the following table, where R is an organic substituent described below.

| | Degree of substitution | |
|---|---|---|
| Structure | with oxygen | Symbol |
| [symbol] | 1 | M |
| 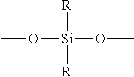 | 2 | D |
| 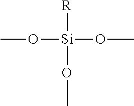 | 3 | T |
| 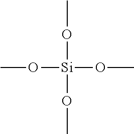 | 4 | Q |

[symbol]

indicates data missing or illegible when filed

The organopolysiloxane material or polymer is obtained by crosslinking from precursors which may be monomeric or polymeric, or intermediately which may be oligomeric. The organopolysiloxane polymer can also be obtained from a mixture of these different kinds of precursors. When the network contains a higher number of T and Q units than D, the crosslinking density is higher. The distribution between the M, D, T and Q units depends on the chemical structure of the precursors, in particular on this distribution M, D, T, Q within the precursors.

The polymeric precursors are organopolysiloxanes. These macromolecules are formed of M, D, T, and/or Q units as described in the table, where R is independently an alkyl group, in particular methyl, or aryl, in particular phenyl, it being possible for different types of R to be present on the same macromolecule.

The organopolysiloxanes may be either linear or slightly branched (majority of D groups) or branched or highly branched (majority of T and Q groups). Linear or slightly branched organopolysiloxanes are generally liquid, more or less viscous at room temperature, and are called silicone oils. Branched or highly branched (pre-crosslinked) organopolysiloxanes form a network at the scale of the individual macromolecule and are called silicone resins. At room temperature, the resins are substantially in solid form, or in liquid form, provided in particular that they have a fairly low molecular mass, in the form of a solution in a solvent or in the form of an aqueous emulsion. They may be copolymerized with organic polymers or oligomers not containing silicon, chosen in particular from polyesters, acrylics, alkyds, polyurethanes and epoxy resins.

When crosslinking is hydrolysis-polycondensation, it is carried out by means of the reactive hydroxy or alkoxy functions, in particular methoxy, ethoxy or butoxy, present on the organopolysiloxane.

When the crosslinking is a polyaddition (or hydrosilylation), it is carried out by reaction between the vinyl reactive functions (—CH═CH₂) present on one of the organopolysiloxanes and the silyl hydride (Si—H) reactive functions present on the other organopolysiloxane mixed with the first.

All these reactive functions are present on each organopolysiloxane, at least one in number, and can be present in number of 2, 3, or more as far as the molecular structure allows. Silicone oils containing at least one reactive function are called “reactive oils”. Reactive functions can be either at the end of a macromolecular chain (termination) or distributed over the chain.

Silicone-polyester resins in particular have silicone/polyester mass ratios, for example 90/10, 80/20, 70/30, 60/40, 50/50, 40/50, 30/70, 20/80, 10/90, advantageously between 80/20 and 50/50.

Linear PDMS silicone oils, pure or pre-emulsified in water, are characterized in the first place by their molecular mass, a direct increasing function of the viscosity of the pure oil. They are then characterized by the presence or absence of reactive functions, for example hydroxyl functions on the silicon atoms (silanol), their number and their location on the molecular chain. For example, reactive oils with viscosity comprised between 50 and 20,000 MPa·s, and, in particular, between 300 and 5,000 MPa·s, may be used, possessing at least one reactive function, preferentially at least 2, which may be placed at the end of the chain.

The polymer precursors reacting by polyaddition may include, for example, polymethylhydrosiloxane, vinylmethylsiloxane, vinyl terminated polydimethylsiloxane (PDMS), in particular linear, vinyl-terminated diphenylsiloxane-dimethylsiloxane copolymers, hydride terminated polydimethylsiloxanes, hydride terminated polyphenyl methylsiloxanes, cyclic vinylmethylsiloxane, vinyl-MQ resin, trimethylsilyl terminated polymethylhydrosiloxane, methylhydrosiloxane and trimethylsiloxane terminated dimethylsiloxane copolymer, MQ resin hydride, and the like, as well as combinations thereof.

Polymeric precursors reacting by hydrolysis-polycondensation, whether silicone resins or silicone oils, can include for example poly(methylsilsesquioxanes), poly(propylsilsesquioxanes), poly(phenylsilsesquioxanes), polydimethylsiloxane (PDMS), trimethylsilyl terminated polydimethylsiloxane hydroxyl terminated (PDMS), polydimethylsiloxane (PDMS), silanol terminated polydimethylsiloxane (PDMS), silanol terminated polyphenylsiloxane (PDMS), silanol terminated diphenylsiloxane-dimethylsiloxane copolymer, poly(2-acetoxyethylsilsesquioxanes), organo-modified alkoxy-silanes and their oligomers, and all similar macromolecules as well as mixtures thereof.

The organopolysiloxane material or polymer can also be obtained by crosslinking a mixture of one or more monomeric precursors and one or more polymeric precursors as described above, as well as one or more oligomeric precursors which may be linear, branched or cyclic. These oligomeric precursors have a lower molecular weight than the polymeric precursors. Polymeric and/or oligomeric precursors containing a number of reactive functional groups as described above greater than 2, advantageously much greater than 2, can be added to the mixture as a co-binder in order to promote a high crosslinking density of the organopolysiloxane polymer finally obtained.

Monomeric, oligomeric and/or polymeric precursors, in particular silicone resins, copolymerized with an organic polymer or not, play the role of polymeric binder in order to obtain the solid organopolysiloxane polymer combined with the thermoplastics of each layer.

Silicone oil-type organopolysiloxane precursors can be considered additives if they are added in a small quantity (usually between 0.1 and 5% dry) to the entire formula of a layer, independently of the other components for the formation of the solid organopolysiloxane polymer.

Crosslinking may require a catalyst:
In the case of crosslinking of organopolysiloxanes by hydrolysis-polycondensation, the formula may include a metal catalyst, such as metal complexes based on platinum, tin, zinc, zirconium and cerium, in particular platinum-cyclovinylmethyl-siloxane complexes, tin ethylhexanoate, zinc ethylhexanoate, zirconium ethylhexanoate, cerium ethylhexanoate and tin dibutyl laurate.
In the case of crosslinking organopolysiloxanes by hydrosilylation, the addition of a catalyst may be necessary: This may be, for example, platinum or a suitable platinum-based catalyst such as Karstedt catalyst or Ashbys catalyst.

A crosslinking agent, for example bearing Si—H bonds, may be present.

According to one embodiment, the proportion of silicone resin in the layer (3b) is greater than or equal to 20% by weight with regard to the total weight of the layer (3b), respectively.

According to another embodiment, the proportion of silicone resin in the layer (3b) is greater than or equal to 40% by weight with regard to the total weight of the layer (3b), respectively.

According to yet another embodiment, the proportion of silicone resin in the layer (3b) is greater than or equal to 50% by weight with regard to the total weight of the layer (3b), respectively.

According to one embodiment, the proportion of silicone resin in the layer (3c) is greater than or equal to 20% by weight with regard to the total weight of the layer (3c), respectively.

According to another embodiment, the proportion of silicone resin in the layer (3c) is greater than or equal to 40% by weight with regard to the total weight of the layer (3c), respectively.

According to yet another embodiment, the proportion of silicone resin in the layer (3c) is greater than or equal to 50% by weight with regard to the total weight of the layer (3c), respectively.

According to one embodiment, the proportion of silicone resin in the layer(s) (3ab) is greater than or equal to 20% by weight with regard to the total weight of the layer (3ab), respectively.

According to another embodiment, the proportion of silicone resin in the layer(s) (3ab) is greater than or equal to 40% by weight with regard to the total weight of the layer (3ab), respectively.

According to yet another embodiment, the proportion of silicone resin in the layer(s) (3ab) is greater than or equal to 50% by weight with regard to the total weight of the layer (3ab), respectively.

### Thermoplastic Polymers

Advantageously, the thermoplastic polymer(s) is (are) chosen from the group composed of polyaryletherketone(s) (PAEK), thermoplastic as aromatic polymer(s) such poly(arylethersulfones) (PAES), poly(arylene sulfides) (PAS) or poly(phenylene oxide) (PPO), liquid crystal polymers, heterocyclic thermoplastic polymers, and mixtures thereof.

### PAEK

Advantageously, the polyaryletherketone(s) (PAEK) is (are) chosen from the group composed of: polyetherketones (PEK), polyetheretherketones (PEEK), polyetherketoneketones (PEKK), polyetheretherketoneketones (PEEKK) and polyetherketoneetherketoneketones (PEKEKK), in a particularly preferred manner is (are) PEEK.

### Other Aromatic Thermoplastic Polymers

Aromatic thermoplastic polymer(s) include, by way of suitable example according to the invention, poly(phenylene oxide) (PPO), poly(arylethersulfones) (PAES) polymer, and, in particular, polyethersulfone (PES), polyphenylene ether sulfone (PPSU), poly(arylene sulfides) (PAS) and, in particular, polyphenylene sulfide (PPS), liquid crystal polymers and mixtures thereof.

### Heterocyclic Thermoplastic Polymers

Suitable examples of heterocyclic thermoplastic polymers according to the invention include polyetherimides (PEI), polyimides (PI), polyamide-imides (PAI) and polybenzimidazole (PBI), or mixtures thereof.

Advantageously, the thermoplastic polymer(s) is (are) chosen from the group composed of polyethersulfone (PES), polyphenylene ether sulfone (PPSU), polyamide-imide (PAI), polyimide (PI), poly(phenylene oxide) (PPO), poly(arylenesulfide) (PAS), polyetherimide (PEI), polybenzimidazole (PBI), liquid crystal polymers (LCP), polyphenylene sulfide (PPS), polyaryletherketone (PAEK) including polyetherketone (PEK), polyetheretherketone (PEEK), polyetherketoneketone (PEKK), polyetheretherketoneketone (PEEKK), polyetherketoneetherketoneketone (PEKEKK) and mixtures thereof.

According to one variant, PAEK is used in the form of a suspension and the PAEK particles in the PAEK suspensions have a particle size with a dD50 of approximately 10 μm to 15 μm.

Advantageously, the nature of the thermoplastic polymer(s) in the layers (3b) and (3c) may be identical or different.

Advantageously, the layer (3b) comprises one or more thermoplastic polymers, preferably in a proportion by weight of said layer of less than 30%, preferably less than 20%.

Advantageously, the layer (3c) comprises one or more thermoplastic polymers, preferably in a proportion by weight of said layer of less than 50%, preferably less than 40%.

Advantageously, the layer(s) (3ab) comprises (comprise) one or more thermoplastic polymers, preferably in a proportion by weight of said layer of less than 50%, preferably less than 40%.

According to one embodiment, the layer (3b) and the layer (3c) comprise one or more thermoplastic polymers, the proportion of thermoplastic polymer(s) in the layer (3c) preferentially being greater than the proportion of thermoplastic polymer(s) in the layer (3b).

According to another embodiment, the layer (3b) and the layer (3c) comprise one or more thermoplastic polymers, the proportion of thermoplastic polymer(s) in the layer (3b) being greater than the proportion of thermoplastic polymer(s) in the layer (3c).

### Fillers

Fillers for the purposes of the invention make it possible to provide mechanical reinforcement and can also provide hydrophobicity properties, while improving the mechanical strength and thermal conductivity of the coating.

Fillers do not have the sole function of providing color to the coating but can contribute to it.

The presence of fillers with excellent thermal conductivity makes it possible to compensate for the low thermal conductivity of PAEK polymers.

Advantageously, the filler(s) is (are) chosen from the group composed of ceramic fillers (SiO₂, etc.) and/or mineral and/or metallic fillers (Al₂O₃, TiO₂, etc.) and/or silicas and/or diamond particles.

Preferentially, the filler(s) is (are) chosen from the group composed of metal oxides, metal carbides, metal oxynitrides, metal nitrides, and mixtures thereof.

Advantageously, said metal is a transition metal, such as at least one of the elements chosen from B, Ni, Ti, Zr or Hf.

More preferably, the filler(s) is (are) chosen from the group composed of:
reinforcing fillers: organic or inorganic hard fillers; inorganic hard fillers are preferably particles of silicon carbides or alumina or zirconia or graphite, or ceramics, or carbonate, or alumina hydrate, aluminum trihydroxide or one or more metal oxides, graphite, graphene;
other reinforcing fillers chosen from metal oxides: silica, micas, lamellar fillers, clays such as montmorillonite, sepiolite, gypsite, kaolinite and laponite, zinc dioxide, quartz, and zirconium phosphate, alumina, zirconia, zinc oxide, copper oxide, iron oxide;
fillers chosen from reinforcing fibers: glass or carbon or aramid fiber;
conductive fillers comprising a transition metal carbide and/or a transition metal nitride, characterized in that the transition metal is at least one of the elements chosen from B, Ni, Ti, Zr or Hf,
for example: Cubic boron nitride, diamond particles, metal particles;
lamellar fillers that can confer lubricating properties, such as clays, graphene or graphite.

Preferred fillers in combination with organopolysiloxanes are:
reinforcing fillers: silica or carbonates with filler contents of min 10-15% by weight and up to 60% by weight;
alumina, alumina hydrate, aluminum trihydroxide;
silica (precipitated or pyrogenic) with a D50<0.1 μm and a BET specific surface area>30 m2/g and preferably comprised between 30 and 500 m2/g,
or mixture of quartz and silica, diatomaceous earths or ground quartz, titanium, mica, talc, kaolin, barium sulfate, slaked lime, zinc oxide, expanded vermiculite, unexpanded vermiculite, calcium carbonate, etc.

More preferably, the filler(s) is (are) chosen from the group composed of alumina, silicon carbide, tungsten carbide, boron nitride, quartz, and mixtures thereof.

Advantageously, the mean diameter D50 of the fillers is comprised between 0.1 and 50 μm, more advantageously between 5 and 15 μm.

Advantageously, the proportion of fillers in a layer is comprised between 0.5 and 30% by dry weight with regard to the total weight of said layer after curing, preferably between 5 and 20%.

Advantageously, the proportion of fillers in the layer (3b) is less than 10% by weight with regard to the total weight of said layer.

Advantageously, the proportion of fillers in the layer(s) (3ab) is less than 10% by weight with regard to the total weight of said layer.

Advantageously, the proportion of fillers in the layer (3c) is less than 10% by weight with regard to the total weight of said layer.

Advantageously, the proportion of fillers in the layers (3b) and (3c) is less than 10% by weight with regard to the total weight, respectively, of the layer (3b)/of the layer (3c).

### Additives

Advantageously, said additives are chosen from the group composed of antifoaming agents, dispersing agents, wetting agents, thickeners, pH adjusters and reactive silicone oils.

The said antifoaming agent(s) is (are) preferentially chosen from the group composed of mineral oils, diols, hydrocarbons, glycerides, oxirane and emulsified fatty acids.

The surfactant(s) is (are) preferentially chosen from the group composed of glycol ether, ethoxylated alcohol with the exclusion of alkyl phenol ethoxylates (APE), and Gemini surfactants.

The dispersing agent(s) is (are) preferentially chosen from the group composed of anionic dispersants such as fatty acid derivatives.

The said thickeners are preferentially chosen from the group composed of acrylic-based or polyurethane-based copolymer, cellulose and pyrogenic silica.

The said pH adjusters are preferentially chosen from the group composed of Bronsted bases: ammonia, amines (triethylamine, triethanolamine, etc.), hydroxides (sodium hydroxide, potassium hydroxide, etc.), carbonates.

Advantageously, the proportion of additives in the layer (3a) is less than 20% by weight with regard to the total weight of said layer.

Advantageously, the proportion of additives in the layer (3b) is less than 20% by weight with regard to the total weight of said layer.

Advantageously, the proportion of additives in the layer (3c) is less than 20% by weight with regard to the total weight of said layer.

Advantageously, the proportion of additives in the layers (3a), (3b) and (3c) is less than 20% by weight with regard to the total weight of the layer (3a)/of the layer (3b)/of the layer (3c).

Advantageously, the proportion of additives in the layer(s) (3ab) is less than 20% by weight with regard to the total weight of said layer.

### Coloring Agents

Advantageously, the coloring agent(s) is (are) chosen from the group composed of thermochromic pigments, thermostable pigments, flakes—preferably holographic flakes—and mixtures thereof.

Advantageously, the proportion of coloring agents in the layer (3b) and the layer (3c) is comprised between 0.5 and 50% by dry weight with regard to the total weight of said layer after curing.

Advantageously, the proportion of coloring agents in the layer (3b) ranges from 10% to 40% by weight with regard to the total weight of said layer.

Advantageously, the proportion of coloring agents in the layer (3c), when they are present, is less than 10% by weight with regard to the total weight of said layer.

Advantageously, the proportion of coloring agents in the layers (3b) and (3c) may be identical or different.

Advantageously, the nature of the coloring agents in the layers (3b) and (3c) may be identical or different.

### Thermochromic Pigments

Preferably, the thermochromic pigment(s) is (are) chosen from the group composed of Bi₂O₃, Fe₂O₃, V₂O₅, WO₃, CeO₂, In₂O₃, Y_{1.84}Ca_{0.16}Ti_{1.84}V_{0.16}O_{1.84}, AgI, (Bi₁₋ₓAₓ) (V_{1-y}M_{y})O₄ where:
x is equal to 0 or x is comprised between 0.001 and 0.999;
y is equal to 0 or is comprised between 0.001 to 0.999;
A and M are chosen from the group composed of nitrogen, phosphorus, an alkali metal, an alkaline earth metal, a transition metal, a poor metal, a metalloid or a lanthanide;
A and M are different from each other.

Given that A and M are different from each other, when:
A is an alkali metal, it can be chosen from Li, Na, K, Rb and Cs;
M is an alkali metal, it can be chosen from Li, Na, K, Rb and Cs;
A is an alkaline earth metal, it can be chosen from Be, Mg, Ca, Sr and Ba;
M is an alkaline earth metal, it can be chosen from Be, Mg, Ca, Sr and Ba;
A is a transition metal, it can be chosen from Sc, Ti Cr, Mn, Fe, Co, Ni, Cu, Y, Zr, Nb, Mo, Ru, Rh, Pd, Ag, Ta, W and Ir;
M is a transition metal, it can be chosen from Sc, Ti Cr, Mn, Fe, Co, Ni, Cu, Y, Zr, Nb, Mo, Ru, Rh, Pd, Ag, Ta, W and Ir;
A is a poor metal, it can be chosen from Al, Zn, Ga, In and Sn;
M is a poor metal, it can be chosen from Al, Zn, Ga, In and Sn;
A is a metalloid, it can be chosen from B, Si, Ge and Sb;
M is a metalloid, it can be chosen from B, Si, Ge and Sb;
A is a lanthanide, it can be chosen from La, Ce, Pr, Nd, Pm, Sm, Eu, Gd, Tb, Dy, Ho, Er, Tm, Yb and Lu;
M is a lanthanide, it can be chosen from La, Ce, Pr, Nd, Pm, Sm, Eu, Gd, Tb, Dy, Ho, Er, Tm, Yb and Lu.

Preferably, A and M different from each other are B and/or Mg.

Preferably, the pigment (Bi₁₋ₓAₓ) (V_{1-y}M_{y})O₄ has a monoclinic scheelite crystallographic form at room temperature.

Preferably, x and y are equal to 0, i.e., the pigment (Bi₁₋ₓAₓ)(V_{1-y}M_{y})O₄ is bismuth vanadate (BiVO₄). Advantageously, a BiVO₄ of monoclinic scheelite crystallographic structure is used at room temperature.

Bismuth vanadate is a yellow inorganic compound of formula BiVO₄, widely used for its coloring properties and for its absence of toxicity. Recorded in the Colour Index International database as Q. I. Pigment Yellow 184, it is especially sold by the companies Heubach (Vanadur®), BASF (Sicopal®), FERRO (Lysopac) or Bruchsaler Farbenfabrik (Brufasol®).

### Thermostable Pigments

Preferably, the thermostable pigment(s) is (are) chosen from the group composed of:
Yellow pigment of the rutile titanium type;
Yellow pigment derived from bismuth, for example selected from stabilized bismuth vanadates (Py₁₈₄);
Red pigment, for example selected from perylene red (for example, PR149, PR178 and PR224), iron oxide;
Orange pigment of the bismuth oxyhalides type (PO₈₅);
Bismuth vanadate orange pigment (PO₈₆);
Zinc tin titanium orange pigment (PO₈₂);
Cerium sulfide orange pigment (PO₇₅; PO₇₈);
Antimony titanium chromium orange-yellow pigment of the rutile type (PBr₂₄);
Tin and zinc orange yellow pigment of the rutile type (Py₂₁₆);
Orange-yellow niobium oxide sulfide tin zinc pigment (Py₂₂₇);
Double tin and niobium oxide orange yellow pigment;
Co₃(PO₄)₂;
LiCoPO₄;
CoAl₂O₄;
Cr₂O₃;
TiO₂;
Black pigment PBk28 (copper chromite black spinel);
and mixtures thereof.

### Flakes

The flakes that can be used in the context of the present invention can be independently chosen from coated or uncoated mica flakes, coated or uncoated silica flakes, coated or uncoated aluminum flakes and coated or uncoated iron oxide flakes. Titanium dioxide coated mica or silica flakes. The flakes which can be used in the context of the present invention can be treated to give a particular color effect.

Advantageously, the flakes are particles chosen from the group composed of particles of mica, aluminum, mica coated with titanium dioxide or mixtures thereof.

### Holographic Flakes

Advantageously, the flakes are holographic flakes, in others words a mixture of magnetizable particles and non-magnetizable particles.

The magnetizable particles may advantageously be particles comprising at least one ferromagnetic metal. These magnetizable particles may be of homogeneous nature, i.e., composed of the same material, or of composite nature, meaning that these magnetizable particles have a core-shell structure, in which the ferromagnetic metal is located in the core and/or in the shell of said particles. Examples of composite magnetizable particles include mica flakes coated with iron oxide Fe₂O₃ or stainless-steel fibers coated with a sol-gel material, as protection against corrosion during the coating steps, or flakes made of plastic material coated with iron oxide Fe₂O₃, or flakes whose core is of ferromagnetic metal and whose shell is formed of a plastic material or of a sol-gel material.

According to one embodiment, a portion of said magnetizable particles is oriented so as to form a three-dimensional decoration.

Advantageously, the mixture of magnetizable particles and non-magnetizable particles represents between 1% and 5% by weight of the weight of the layer, preferably between 2% and 3% by weight.

Advantageously, the percentage of non-magnetizable particles in the mixture of magnetizable particles and non-magnetizable particles is comprised between 15% and 40% by weight with regard to the total weight of the mixture of magnetizable particles and non-magnetizable particles.

Advantageously, the magnetizable particles have a dimension D50 less than or equal to 23 μm.

The term “D50” is understood to mean, for the purposes of the present invention, the maximum dimension exhibited by 50% of the particles by number.

Advantageously, the non-magnetizable particles have a dimension D90 comprised between 20% and 250% of the dimension D90 of the magnetizable particles.

The term “D90” is understood to mean, for the purposes of the present invention, the maximum dimension exhibited by 90% of the particles by number.

Advantageously, the magnetizable particles and/or the non-magnetizable particles are colored on the surface.

Advantageously, the non-magnetizable particles are composed of mica, aluminum or mica coated with titanium dioxide.

Advantageously, the magnetizable particles are composed of iron, iron oxide, iron-coated aluminum or iron-coated mica, the iron being in ferritic form.

### Decorations

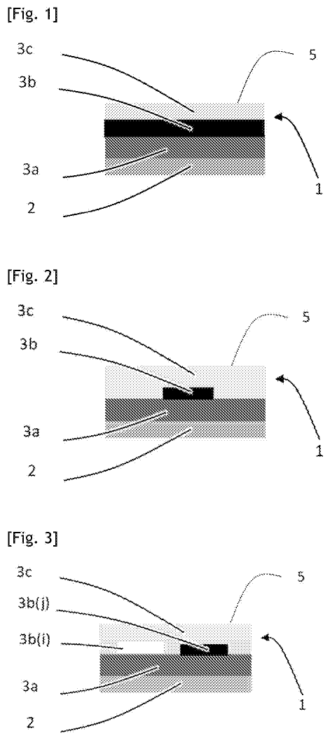

According to one embodiment, the layer(s) (3b) is (are) continuous and cover the entire layer (3a) (see FIG. 1).

According to another embodiment, the layer(s) (3b) do not cover the entire layer (3a) and forms (form) at least one decoration (see FIG. 2).

Advantageously, the layer(s) (3b) comprises (comprise) several decorations, one (i) comprising one or more thermochromic pigments and the other (j) comprising at least one reference temperature pigmentary composition (see FIG. 3).

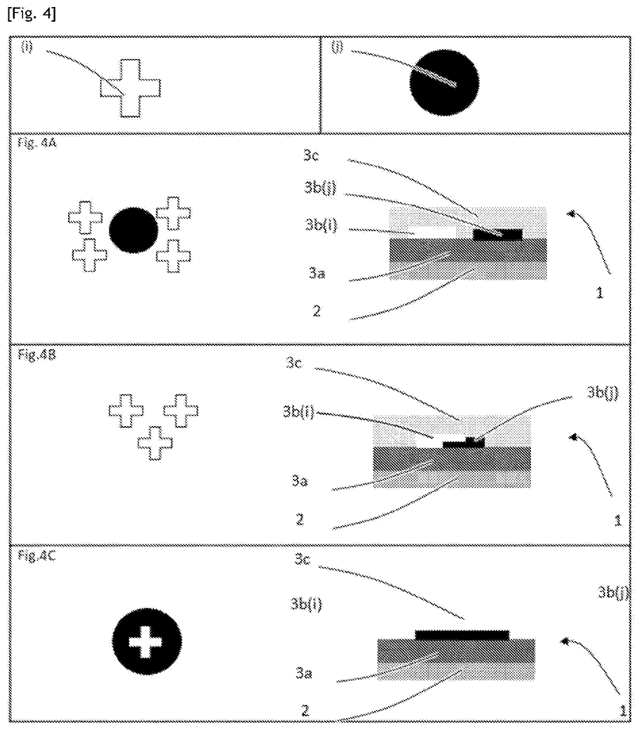

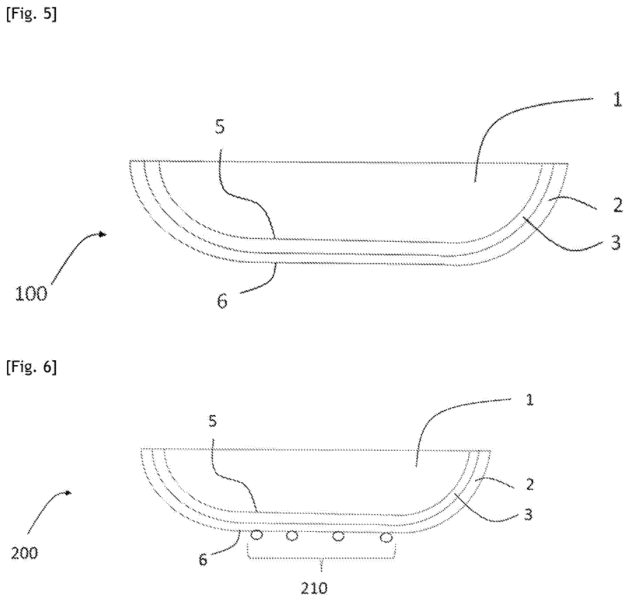

According to one embodiment, each of the two decorations (i) and (j) is in the form of adjacent non-overlapping patterns. For example, each decoration is represented by different geometric patterns distributed uniformly over the entire surface and alternating with regard to one another (see FIG. 4A).

According to another embodiment, the two decorations (i) and (j) are partially overlapping. For example, each decoration is represented by different geometric patterns uniformly distributed over the entire surface and partially overlapping (see FIG. 4B).

Preferably, the two decorations (i) and (j) are overlapping, either because one of the two decorations is a continuous layer and the other decoration covers it in the form of patterns, or because the two decorations (i) and (j) are in the form of overlapping patterns (see FIG. 4C).

### METHOD

The invention also concerns a method of manufacturing a coated cooking element (1) according to the invention comprising the following successive steps:
i. supplying a metal substrate (2) comprising at least one face (2a) to be coated;
ii. optionally, pre-treating the face (2a) of said metal substrate (2) intended to be coated;
iii. applying a sol-gel base layer (3a) on the face (2a) to be coated;
iv. optionally drying and/or curing of the base layer (3a);
v. applying at least one intermediate layer (3b), typically by pad printing, screen printing, inkjet printing or flexography;
vi. optionally, drying of the intermediate layer(s) (3b);
vii. applying at least one finishing layer (3c); and
viii. curing of all base (3a), intermediate (3b) and finishing (3c) layers.

Step (iii) is especially carried out as described above in connection with the sol-gel composition.

According to one embodiment, the at least one intermediate layer (3b) is applied to the at least one base layer (3a) and/or the at least one finishing layer (3c) is applied to the at least one intermediate layer (3b).

Advantageously, the steps of the method according to the invention make it possible to coat the metal substrate (2) with a coating (3) formed by the three layers (3a), (3b), and (3c). Generally, these three layers are wet during their application. “Wet layer” is understood to mean, for the purposes of the present invention, that the layer comprises all or part of its solvents.

Preferably, all or part of the solvents of the wet layer are removed, either naturally or by a physical treatment, for example by thermal drying, by air flow drying or by vacuum treatment.

Advantageously, the coating composition according to the invention may also comprise at least one solvent. Advantageously, the solvent may be protic. Advantageously, the solvent may be non-toxic.

The solvent which can be used in the coating composition according to the invention may advantageously comprise at least one alcohol and may preferably be chosen from isopropanol, methanol, ethanol and mixtures thereof.

The coating is applied in several layers. In this case, the deposition on at least one of the two opposite faces of said substrate of at least one layer of the coating (3) according to the invention is repeated several times. Preferably, a drying step is carried out between the application of each layer, then said coated substrate is cured after application of the last layer. The application of the coating (3) by the method according to the invention to the substrate (2) makes it possible to obtain a thermostable coating layer.

The coating formula to be applied is generally in aqueous form, the polymers of the polymeric phase being in the form of suspensions. Other non-aqueous solvents may also be suitable.

Advantageously, the method for manufacturing a coated cooking element (1) according to the invention comprises one or more drying steps between 8° and 150 °C after application of each of the layers. Drying can be carried out by convection or infrared.

The coating according to the invention can be applied by the method according to the invention on the shaped substrate or on a locally flat area of the shaped substrate. A thermostable coating layer is obtained. Generally, this coating layer is wet.

Advantageously, the method of manufacturing a coated cooking element (1) according to the invention comprises a step of shaping said substrate (2) before step iii. Shaping is also called stamping.

The coating is preferentially carried out by spraying.

The method according to the invention advantageously comprises a step viii. of curing the element obtained in step vii. of the method. For the purposes of the present invention, curing of the coated substrate is understood to mean a heat treatment which makes it possible to densify the coating layer or layers applied to the substrate, but also to crosslink the organopolysiloxane precursors (silicone resin).

Curing is carried out in step viii. Generally, the curing temperature of step viii. is comprised between 230 °C and 420 °C.

Advantageously, the method for manufacturing a coated cooking element (1) according to the invention comprises a single final curing step viii. of all the applied layers. This single curing step is carried out simultaneously for all the applied layers.

Steps (iii) and (vii) of application can be carried out by electrostatic powder coating, by spraying in solvent or aqueous phase, by screen printing, by roller printing or by digital printing.

Preferably, step (vii) is especially carried out by electrostatic powder coating or by spraying in solvated or aqueous phase.

For the purposes of the present invention, curing of the coated substrate is understood to mean a heat treatment which makes it possible to densify the coating layer or layers applied to the substrate, but also to crosslink the organopolysiloxane precursors (silicone resin).

The curing step iv, when carried out, is typically carried out at a temperature comprised between 200 °C and 350 °C for 5 minutes to 30 minutes.

Typically, the substrate has the final shape of the culinary item with a concave inner face 2a intended to be disposed on the side of the foods likely to be introduced into said item, and a convex outer face intended to be disposed on the side of a heat source.

### Preferred Architectures

According to one embodiment, the invention concerns a coated cooking element (1) for a culinary item or electric cooking appliance, containing a metal substrate (2) coated on at least one face (2a) by, or exclusively by, the following three layers superposed in this order from the metal substrate (2):
(3a) a base layer comprising one or more sol-gel compositions;
(3b) one or more intermediate layers, preferably two, composed of one or more coloring agents; and, optionally
   one or more silicone resins; and/or
   one or more thermoplastic polymers; and/or
   one or more fillers; and/or
   one or more additives.
   (3c) a finishing layer intended to come into contact with food during cooking composed of one or more silicone resin(s); and, optionally
(3c) one or more thermoplastic polymers; and/or
   one or more fillers; and/or
   one or more additives; and/or
   flakes.

According to one embodiment, the base layer (3a) is composed of an SG composition synthesized by a sol-gel route from an SG mixture composed of a precursor of the metal alkoxide type such as TEOS or MTES; and
a colloidal metal oxide precursor;
a solvent, preferably alcoholic;
an acid chosen from acetic acid, citric acid, ethyl acetoacetate, hydrochloric acid or formic acid; and, optionally
additives chosen from at least one pigment, at least one advantageously mineral filler, flakes, especially metal flakes, pyrogenic silica, or a mixture thereof, preferably chosen from pigments and/or fillers.

Typically, the thickness of the layer (3a) is comprised between 5 μm and 30 μm.

Preferably, the coloring agent of the intermediate layer(s) (3b) comprises (comprise) pigments and/or flakes, advantageously holographic flakes.

According to a variant, the intermediate layer(s) (3b) is (are) composed of:
one or more coloring agents, especially pigments and/or flakes, advantageously holographic flakes;
one or more thermoplastic polymers advantageously chosen from polyamide-imide (PAI), polyimide (PI), polyetherimide (PEI), polybenzimidazole (PBI), polyethersulfone (PES), polyphenylene ether sulfone (PPSU), polyaryletherketone (PAEK), and mixtures thereof;
0 to 10% fillers;
0 to 20% additives;
Optionally one or more silicone resins.

According to another variant, the intermediate layer(s) (3b) is (are) composed of:
one or more coloring agents, especially pigments and/or flakes, advantageously holographic flakes;
0 to 10% fillers;
0 to 20% additives;
one or more silicone resins; and
optionally, one or more thermoplastic polymers advantageously chosen from polyamide-imide (PAI), polyimide (PI), polyetherimide (PEI), polybenzimidazole (PBI), polyethersulfone (PES), polyphenylene ether sulfone (PPSU), polyaryletherketone (PAEK), and mixtures thereof.

According to a particular variant, the intermediate layer(s) (3b) does (do) not comprise silicone resin.

According to another particular variant, the intermediate layer(s) (3b) is (are) composed of:
one or more coloring agents, especially pigments and/or flakes, advantageously holographic flakes;
one or more thermoplastic polymers advantageously chosen from polyamide-imide (PAI), polyimide (PI), polyetherimide (PEI), polybenzimidazole (PBI), polyethersulfone (PES), polyphenylene ether sulfone (PPSU), polyaryletherketone (PAEK), and mixtures thereof;
0 to 10% fillers;
0 to 20% additives;
one or more silicone resins.

According to a particular embodiment, the coating comprises two intermediate layers (3b), at least one of which is decorative. Advantageously, the layer(s) (3b) are composed of several decorations, one (i) comprising one or more thermochromic pigments and the other (j) comprising at least one reference temperature pigmentary composition.

Typically, the thickness of the intermediate layer(s) (3b) is comprised between 3 μm and 10 μm.

Preferably, the intermediate layer(s) (3b) only partially covers (cover) the base layer (3a).

According to one embodiment, the finishing layer (3c) is composed of one or more silicone resins and optionally of one or more thermoplastic polymers.

According to another embodiment, the finishing layer (3c) is composed of one or more silicone resins and one or more thermoplastic polymers.

Typically, the thickness of the layer (3c) is comprised between 0.1 μm and 10 μm.

In a particular embodiment, the thickness of the sublayer (3a) is comprised between 5 and 30 μm, the thickness of the layer (3b) is comprised between 3 μm and 10 μm, and the thickness of the layer (3c) is comprised between 0.1 μm and 10 μm.

### Item

The invention also concerns a culinary item (100) comprising a coated cooking element (1).

According to one embodiment, the culinary item (100) has a heating face (6) intended to be brought into contact with an external heating source, the heating face (6) being opposite the cooking face (5) intended to be brought into contact with the food during cooking. The cooking face (5) is typically the face (2a) intended to be coated with the coating of the invention.

Advantageously, the culinary item (100) according to the invention is chosen from the group composed of saucepan, frying pan, skillet or fondue pot, raclette, Dutch oven, wok, sauté pan, crepe maker, grill, griddle, marmite, cocotte, insert for an electric cooker or bread maker, or food mold.

The invention also concerns an electric cooking appliance (200) having a coated cooking element (1) according to the invention and a heating source (210) configured to heat the coated cooking element (1).

Advantageously, the electric cooking appliance (200) is chosen from the group composed of electric crepe maker, electric raclette appliance, electric fondue appliance, electric grill, electric griddle, electric cooker, bread maker, electric pressure-cooking appliance, waffle makers, rice cookers and jam makers.

The culinary item according to the present invention may especially be a culinary item in which one of the two opposite faces of the substrate is an inner face, optionally concave, intended to be disposed on the face where the food will be introduced into or onto said item, and in which the other face of the substrate is an outer face, optionally convex, intended to be disposed toward a heat source.

Non-limiting examples of culinary items in accordance with the present invention, especially include culinary items such as saucepans and frying pans, woks and sauté pans, Dutch ovens and marmites, crepe makers, baking molds and sheets, barbecue griddles and grills, food prep bowls.

### EXAMPLES

The aims, aspects and advantages of the present invention will be better understood from the description given below of a particular embodiment of the invention presented by way of non-limiting example.

Of course, the invention is in no way limited to the embodiment described and illustrated, which has been given only by way of example. Modifications remain possible, especially from the viewpoint of the constitution of the various elements or by substitution of technical equivalents, without thereby exceeding the scope of protection of the invention.

### Examples of Embodiment

Metal substrate: this is a sandblasted or shot-blasted aluminum substrate that then undergoes a suitable surface treatment to remove organic contaminants.

The raw materials for the layer (3a) are detailed below.

Raw materials for intermediate layers (3b), (3b′) and finishing layer (3c):
Silicone resins:
   RS1: Ethoxy functionalized polyester silicone resin (80% silicone/20% polyester) in solvent phase, viscosity at 25 °C approx. 2000 mPas, Solids content=75%;
   RS2: Ethoxy functionalized polyester silicone resin (50% silicone/50% polyester) in solvent phase, viscosity at 25 °C approx. 2000 mPas, Solids content=75%;
   RS3: Ethoxy functionalized polyester silicone resin (30% silicone/70% polyester) in solvent phase, viscosity at 25 °C approx. 2000 mPas, Solids content=75%;
   RS4: Methyl phenyl functionalized polyester silicone resin in solvent phase, viscosity at 25 °C approx. 2000 mPas, Solids content=75%;
   RS5: Methoxy functionalized polyester silicone resin (50% silicone/50% polyester) in solvent phase, viscosity at 25 °C approx. 2000 mPas, Solids content=75%;
   RS6: Ethoxy-functionalized methyl organopolysiloxane resin in aqueous emulsion, viscosity at 25 °C approx. 1500 mPas, Solids content=52%;
Alcohol solvent
   dipropylene glycol n-butyl ether (DPNB);
   2-methoxy-1-methylethyl acetate (MPA);
   Butyl glycol acetate (BGA);
   Butyl acetate;
Surfactant and antifoaming agent;
   Mineral oil: Tego Foamex K7 from Evonik.
   Fatty alcohol polyglycol ether: Genapol X080 from Clariant or Tergitole TMN-100X;
Reinforcing fillers:
   Pyrogenic silica: Levasil CC301;
   Post-treated dimethyldichlorosilane fumed silica: Aerosil R972.
Pigments:
   Mica: IRIODIN 100 or IRIODIN 300 and/or Magnapearl 5000;
   Cr/Fe oxide: Sicopal black K0098FK;
   Carbon black: Derussol F25 or Cabot Monarch 4750;
   Perylene red: Paliogen red (PR178);
   Iron trioxide: brick H856.
Acrylic resin:
   Rohagit SD 15: 30% acrylic polymer solution in aqueous phase.
Silicone oil:
   Polyether modified polysiloxane: TEGO GLIDE 100;
   Polydimethylsiloxane oil: CT 601M.
Other additives:
   AMP 90: solution of 2-amino-2-methyl-1-propanol: 90% polymer in aqueous phase, buffering agent;
   Metolat 368: fatty acid ester;
   Dolfynox 1030: Propoxylated polyglycol ether, wetting agent;
   Edaplan LA 451: anionic ester in ethanol/water, wetting agent;
   Tego Glide 407: methyl phenyl polysiloxane, flow agent.

### Working Principle of the Jar Mill (Mechanical Milling)

Ball milling consists of loading a jar with the sample to be milled and so-called milling balls and rotating the jar around its axis at a certain speed. The jar is usually rotated using a roller machine. The sample may be milled dry or dispersed in a suitable solvent (e.g., water or alcohol). The dispersion may also contain certain adjuvants (such as a dispersant or an antifoam).

The mean diameter of the milling balls must be adapted to the size of the particles to be milled. The finer the particles, the smaller the diameter of the balls to be used. The total volume of balls, including the voids between the balls, will represent approximately 50-60% of the internal volume of the jar. The balls of different sizes are advantageously distributed according to the following proportion by weight in relation to the total weight of the balls: 25% small balls, 50% medium balls and 25% large balls. The size of the smallest balls is comprised between 2 and 10 mm. Alumina and stabilized zirconia are commonly used as the material of the balls.

### Example According to the Invention: Preparation of a Coating with a Black Sol-Gel Primer (Layer 3a), Two Intermediate Layers (3b) and (3b′) and a Finishing Layer (3c)

The formulation of base layer 3a (black primer) is prepared from a three-component system: part A, part B and part C. Part A is a colloidal silica, with a particle size of less than 200 nm, which can optionally be impregnated with a hydrophobic compound such as PDMS oil. Part B incorporates the reactive silane MTMS and the acid catalyst. Part C incorporates pigments, fillers, solvents, wetting agent, and PDMS oil. The PDMS oil can also be introduced into part B.

Black primer base layer (3a)

| Components of the layer 3a | Part | Mass in g |
|---|---|---|
| Colloidal silica (30%) | A | 41.2 |
| MTMS | B | 29.1 |
| Acetic acid | B | 0.9 |
| Isopropanol | C | 3.3 |
| Butyl glycol | C | 0.9 |
| Hydroxylated PDMS oil | C | 1.2 |
| Black pigment | C | 15.5 |
| Micro alumina | C | 7.8 |
| Wetting agent | C | 0.1 |
| TOTAL | | 100 |

The method is as follows:
Part A is stirred with a shearing blade and a speed of 1000 rpm, sufficient to obtain a clear vortex.
Part B is prepared separately by mixing the silane with the acid, then introduced with stirring into part A: The hydrolysis reaction of the MTMS then begins and must continue for at least 2 hours.
Part C is then introduced into this mixture by incorporating the components one by one, still with stirring. It should be noted that all the components of part C can be premixed separately, before introducing this paste into the A+B mixture after 2 hours of reaction.

Once all the components are mixed, stirring continues for 30 minutes, then the formulation is stored in a closed glass vial.

Note also, in terms of the mixing method, that the components of part C can also be first introduced into part A and left stirring for 30 minutes, then part B is introduced alone and mixed for 2 hours for the sol-gel reaction.

The mixture is then left at room temperature for 24 hours before application. The shelf life of this formulation is at least 48 h.

The mixture can also be stored in the refrigerator at 5 °C: In this case, its shelf life is increased to at least 72 hours.

The mixture obtained is then filtered with a 50 micron filter before being sprayed onto a sandblasted and degreased aluminum substrate, pre-heated to 55 °C to avoid any dripping during coating.

A step of drying the base layer (3a) at a temperature below 100 °C is carried out. The layer (3a) is cured at 300 °C, with a gradual increase and a plateau of 10 minutes at this temperature of 300 °C.

The base layer (3a) will have a dry thickness of 30 to 40 microns.

### Intermediate Layer (3b)

A continuous layer (3b) chosen from the layer compositions as described below is then deposited by spraying on the layer (3a): layer 3b1, layer 3b2 and layer 3b3:

| | | | % solid |
|---|---|---|---|
| | | | phase, |
| | | | after |
| Component of layer 3b1 | role | % liquid | curing |
| Silicone resin: | binder | 30 | 59.6 |
| RS1 or RS2 or RS3 or RS4 or RS5 | | | |
| or RS6 | | | |
| dipropylene glycol n-butyl ether | solvent | 3 | 0 |
| Fatty acid ester | | 3 | 0.5 |
| Cr/Fe oxide | pigment | 10 | 33.1 |
| Deionized water | solvent | 41.40 | 0 |
| Fatty alcohol polyglycol ether | | 4.60 | 0.6 |
| Mineral oil | Anti- | 2 | 0.7 |
| | foaming | | |
| | agent | | |
| silica | | 5 | 5 |
| 2-amino-2-methyl-1-propanol | | 0.5 | 0 |
| Acrylic polymer | thickener | 0.5 | 0.5 |
| TOTAL | | 100 | 100 |

| | | | % solid |
|---|---|---|---|
| | | | phase, after |
| Component of layer 3b2 | role | % liquid | curing |
| Silicone resin: | binder | 30 | 44.8 |
| RS1 or RS2 or RS3 or | | | |
| RS4 or RS5 or RS6 | | | |
| Thermoplastic polymers: | binder | 10 | 24.9 |
| PES or PAI or PEEK | | | |
| dipropylene glycol | solvent | 3 | 0 |
| n-butyl ether | | | |
| Fatty acid ester | | 3 | 0.4 |
| Cr/Fe oxide | pigment | 10 | 24.9 |
| Deionized water | solvent | 31.40 | 0 |
| Fatty alcohol | | 4.60 | 0.5 |
| polyglycol ether | | | |
| Mineral oil | Anti-foaming agent | 2 | 0.5 |
| silica | | 5 | 3.7 |
| 2-amino-2-methyl- | | 0.5 | 1.14 |
| 1-propanol | | | |
| Acrylic polymer | thickener | 0.5 | 0.4 |
| TOTAL | | 100 | 100 |

| | | | % solid |
|---|---|---|---|
| | | | phase, after |
| Component of layer 3b3 | role | % liquid | curing |
| Silicone resin RS2 | binder | 62 | 78.81 |
| 2-methoxy-1-methylethyl acetate | solvent | 8 | 0 |
| Cr/Fe oxide | Pigment | 10 | 21.19 |
| Butyl glycol acetate | solvent | 1 | 0 |
| Butyl acetate | solvent | 19 | 0 |
| TOTAL | | 100 | 100 |

The aqueous composition of the layer 3b is prepared according to the ball milling principle. Ball milling is carried out in a jar as described above. The sample may be milled dry or dispersed in a suitable solvent (e.g. water, alcohol or solvent). The dispersion may also contain certain adjuvants (such as a dispersant or an antifoam).

The thickness of this layer 3b is comprised between 10 μm and 20 μm, preferably 12 μm to 15 μm.

Intermediate Layer (3b′) and Finishing Layer (3c)

The substrate, on which the base layer (3a) and the continuous layer (3b) as described above are applied, is coated with a multilayer non-stick coating composed of an intermediate layer 3b′ (6-8 μm) which is dried for 4 minutes at 100 °C and a finishing layer 3c (14-18 μm). The whole is finally cured at 250 °C for 1 hour.

The compositions of the intermediate layers (3b′) are deposited by spraying and are as described below: layer 3b′1, layer 3b′2 and layer 3b′3:

| | | | % solid |
|---|---|---|---|
| Component of the | | | phase, after |
| intermediate layer 3b′1 | role | % liquid | curing |
| Silicone resin: | binder | 30 | 73.5 |
| RS1 or RS2 or RS3 or | | | |
| RS4 or RS5 or RS6 | | | |
| dipropylene glycol | solvent | 3 | 0 |
| n-butyl ether | | | |
| Fatty acid ester | Wetting agent | 3 | 0.6 |
| mica | flakes | 3 | 12.3 |
| Cr/Fe oxide | pigment | 1 | 4.1 |
| Deionized water | solvent | 46.40 | 0 |
| Fatty alcohol | Emulsifying agent | 4.60 | 0.8 |
| polyglycol ether | | | |
| Mineral oil | Anti-foaming agent | 2 | 0.8 |
| silica | | 5 | 6.1 |
| 2-amino-2-methyl- | | 0.5 | 0 |
| 1-propanol | | | |
| Acrylic polymer | thickener | 1.5 | 1.8 |
| TOTAL | | 100 | 100 |

| | | | % solid |
|---|---|---|---|
| Component of the | | | phase, after |
| intermediate layer 3b′2 | role | % liquid | curing |
| Silicone resin: | binder | 30 | 80 |
| RS1 or RS2 or RS3 or | | | |
| RS4 or RS5 or RS6 | | | |
| dipropylene glycol | solvent | 5 | 0 |
| n-butyl ether | | | |
| Propoxylated | Wetting agent | 1 | 0.1 |
| polyglycol ether | | | |
| Perylene red | pigment | 3 | 13.3 |
| Carbon black | pigment | 2 | 2.9 |
| Deionized water | solvent | 52 | 0 |
| Fatty alcohol | Emulsifying agent | 2 | 0.4 |
| polyglycol ether | | | |
| Mineral oil | Anti-foaming agent | 3 | 1.3 |
| 2-amino-2-methyl- | Buffering agent | 0.5 | 0 |
| 1-propanol | | | |
| Acrylic polymer | thickener | 1.5 | 2 |
| TOTAL | | 100 | 100 |

| | | | % solid |
|---|---|---|---|
| Component of the | | | phase, after |
| intermediate layer 3b′3 | role | % liquid | curing |
| Silicone resin: | binder | 30 | 75.4 |
| RS1 or RS2 or RS3 or | | | |
| RS4 or RS5 or RS6 | | | |
| dipropylene glycol | solvent | 5 | 0 |
| n-butyl ether | | | |
| Propoxylated | Wetting agent | 1 | 0.1 |
| polyglycol ether | | | |
| iron trioxide | pigment | 5 | 21.0 |
| Deionized water | solvent | 52 | 0 |
| Fatty alcohol | Emulsifying agent | 2 | 0.3 |
| polyglycol ether | | | |
| Mineral oil | Anti-foaming agent | 3 | 1.3 |
| 2-amino-2-methyl- | Buffering agent | 0.5 | 0 |
| 1-propanol | | | |
| Acrylic polymer | thickener | 1.5 | 1.9 |
| TOTAL | | 100 | 100 |

The compositions of the finishing layers (3c) are deposited by spraying and are as described below: layer 3c1 to 3c10:

| | | | % solid |
|---|---|---|---|
| Component of the | | | phase, after |
| finishing layer 3c1 | role | % liquid | curing |
| Silicone resin RS1 | binder | 35 | 95.5 |
| dipropylene glycol | solvent | 6 | 0 |
| n-butyl ether | | | |
| Propoxylated | | 2 | 0.3 |
| polyglycol ether | | | |
| Mineral oil | Anti-foaming agent | 1 | 0.5 |
| Mica | pigment | 0.5 | 2.3 |
| Deionized water | solvent | 50.5 | 0 |
| Fatty alcohol | Emulsifying agent | 4 | 0.7 |
| polyglycol ether | | | |
| 2-amino-2-methyl- | Buffering agent | 0.5 | 0 |
| 1-propanol | | | |
| Acrylic polymer | thickener | 0.5 | 0.7 |
| TOTAL | | 100 | 100 |

| | | | % solid |
|---|---|---|---|
| Component of the | | | phase, after |
| finishing layer 3c2 | role | % liquid | curing |
| Silicone resin RS1 | binder | 35 | 91.5 |
| dipropylene glycol | solvent | 6 | 0 |
| n-butyl ether | | | |
| anionic ester in | Wetting agent | 1 | 0.1 |
| ethanol/water | | | |
| Mineral oil | Anti-foaming agent | 1 | 0.4 |
| Polyether modified | oil | 0.5 | 2.2 |
| polysiloxane | | | |
| polydimethylsiloxane oil | oil | 1 | 4.4 |
| Deionized water | solvent | 50.50 | 0 |
| Fatty alcohol | Emulsifying agent | 4 | 0.7 |
| polyglycol ether | | | |
| 2-amino-2-methyl- | Buffering agent | 0.5 | 0 |
| 1-propanol | | | |
| Acrylic polymer | thickener | 0.5 | 0.7 |
| TOTAL | | 100 | 100 |

| | | | % solid |
|---|---|---|---|
| Component of the | | | phase, after |
| finishing layer 3c3 | role | % liquid | curing |
| Silicone resin RS1 | binder | 67 | 100 |
| 2-methoxy-1-methylethyl acetate | solvent | 33 | 0 |

| | | | % solid |
|---|---|---|---|
| Component of the | | | phase, after |
| finishing layer 3c4 | role | % liquid | curing |
| Silicone resin RS4 | binder | 69 | 100 |
| 2-methoxy-1-methylethyl acetate | solvent | 31 | 0 |

| | | | % solid |
|---|---|---|---|
| Component of the | | | phase, after |
| finishing layer 3c5 | role | % liquid | curing |
| Silicone resin RS4 | binder | 80 | 100 |
| 2-methoxy-1-methylethyl acetate | solvent | 20 | 0 |

| | | | % solid |
|---|---|---|---|
| Component of the | | | phase, after |
| finishing layer 3c6 | role | % liquid | curing |
| Silicone resin RS1 | binder | 75 | 87.38 |
| 2-methoxy-1-methylethyl acetate | solvent | 8 | 0 |
| methyl phenyl polysiloxane | Flow agent | 0.5 | 0.97 |
| Carbon black | Pigment | 5 | 9.71 |
| Post-treated dimethyl | filler | 1 | 1.94 |
| dichlorosilane fumed silica | | | |
| Butyl glycol acetate | solvent | 1 | 0 |
| Butyl acetate | solvent | 9.5 | 0 |
| TOTAL | | 100 | 100 |

| | | | % solid |
|---|---|---|---|
| Component of the | | | phase, after |
| finishing layer 3c7 | role | % liquid | curing |
| Silicone resin RS1 | binder | 75 | 94.74 |
| 2-methoxy-1- | solvent | 8 | 0 |
| methylethyl acetate | | | |
| Post-treated dimethyl | filler | 2 | 4.21 |
| dichlorosilane fumed silica | | | |
| mica | Pigment | 0.5 | 1.05 |
| Butyl glycol acetate | solvent | 1 | 0 |
| Butyl acetate | solvent | 13.5 | 0 |
| TOTAL | | 100 | 100 |

| | | | % solid |
|---|---|---|---|
| Component of the | | | phase, after |
| finishing layer 3c8 | role | % liquid | curing |
| Silicone resin RS6 | binder | 30 | 74.26 |
| Post-treated dimethyl | filler | 2 | 8.25 |
| dichlorosilane | | | |
| fumed silica | | | |
| dipropylene glycol | solvent | 4.5 | 0 |
| n-butyl ether | | | |
| Fatty acid ester | | 3 | 5.94 |
| Mica | pigment | 0.5 | 2.06 |
| Deionized water | solvent | 51.6 | 0 |
| Fatty alcohol | Emulsifying agent | 5.5 | 4.99 |
| polyglycol ether | | | |
| Mineral oil | Anti-foaming agent | 1.9 | 4 |
| 2-amino-2-methyl- | Buffering agent | 0.5 | 0 |
| 1-propanol | | | |
| Acrylic polymer | thickener | 0.5 | 0.5 |
| TOTAL | | 100 | 100 |

| | | | % solid |
|---|---|---|---|
| Component of the | | | phase, after |
| finishing layer 3c9 | role | % liquid | curing |
| Silicone resin RS2 | binder | 70 | 94.74 |
| 2-methoxy-1- | solvent | 8 | 0 |
| methylethyl acetate | | | |
| Post-treated dimethyl | filler | 2 | 4.21 |
| dichlorosilane fumed silica | | | |
| mica | Pigment | 0.5 | 1.05 |
| Butyl glycol acetate | solvent | 1 | 0 |
| Butyl acetate | solvent | 13.5 | 0 |
| TOTAL | | 100 | 100 |

| | | | % solid |
|---|---|---|---|
| Component of the | | | phase, after |
| finishing layer 3c10 | role | % liquid | curing |
| Silicone resin RS1 | binder | 60 | 92.78 |
| 2-methoxy-1- | solvent | 8 | 0 |
| methylethyl acetate | | | |
| Post-treated dimethyl | filler | 2 | 4.21 |
| dichlorosilane fumed silica | | | |
| mica | Pigment | 0.5 | 1.05 |
| Butyl glycol acetate | solvent | 1 | 0 |
| Polydimethylsiloxane oil | oil | 1 | 2.06 |
| Butyl acetate | solvent | 19.7 | 0 |
| TOTAL | | 100 | 100 |

### Method for Evaluating the Properties of the Non-Stick Coating: Egg Performance Test

The method for evaluating the properties of the non-stick coating is carried out using the egg test adapted from AFNOR NF D 21-511 paragraph 3.3.2, and implemented as follows:
The sample is cleaned, then the remaining water is wiped off the surface.
The inner surface of the container body is dried beforehand.
The cooking vessel is heated on a gas stove to a temperature comprised between 14° and 170 °C.
A calibre [French size labeling] 60/65 egg is broken and poured centrally onto the hot cooking vessel and the egg is allowed to coagulate (6 to 9 minutes); the egg is removed from the cooking vessel with a spatula, the coating is cleaned with a damp plant-based sponge and the non-stick properties of the cooking vessel are evaluated through this action, then recorded:
Grade of 100: The egg can be removed entirely with a plastic spatula;
Grade of 75: The egg is not completely removed but the coating is easily cleaned with a damp sponge;
Grade of 50: The egg is not completely removed but the coating is cleanable with a damp sponge;
Grade of 25: The egg is not completely removed and the coating is not cleaned with a damp sponge;
Grade of 0: The egg is not removed and the coating cannot be cleaned with a damp sponge.

| | Constructions/architectures of cooking | | | | | | | | | |
|---|---|---|---|---|---|---|---|---|---|---|
| | elements according to the invention | | | | | | | | | |
| Base layer (3a) | According to the example | | | | | | | | | |
| Intermediate layer | 3b1 or 3b2 or 3b3 | | | | | | | | | |
| (3b) | | | | | | | | | | |
| Intermediate layer | 3b′1 or 3b′2 or 3b′3 | | | | | | | | | |
| (3b') | | | | | | | | | | |
| Finishing layer (3c) | 3c1 | 3c2 | 3c3 | 3c4 | 3c5 | 3c6 | 3c7 | 3c8 | 3c9 | 3c10 |
| Grades obtained in | 50 | 50 | 50 | 50 | 50 | 50 | 50 | 50 | 50 | 50 |
| the egg test | | | | | | | | | | |

All the coatings according to the invention based on silicone-polyester resins have good non-stick properties while being adherent to the metal.

1-19. (canceled)

20. A coated cooking element for a culinary item or an electric cooking appliance, comprising a metal substrate coated on at least one face with at least the following layers and in this order from the metal substrate:
a base layer comprising one or more sol-gel compositions;
one or more intermediate layers composed of one or more coloring agents; and, optionally
one or more silicone resins; and/or
one or more thermoplastic polymers; and/or
one or more fillers; and/or
one or more additives
a finishing layer intended to come into contact with food during cooking composed of one or more silicone resin(s); and
one or more thermoplastic polymers; and/or
one or more fillers; and/or
one or more additives; and/or
flakes.

21. The coated cooking element according to claim 20, wherein the silicone resin(s) is (are) chosen from the group composed of methyl silicone resins and/or phenyl silicone resins and/or methyl phenyl silicone resins, methyl silicone-polyester resin (copolymers), phenyl silicone-polyester resin (copolymers), methyl phenyl silicone-polyester resin, silicone-alkyd resin (copolymers), modified silicone resin and mixtures thereof.

22. The coated cooking element according to claim 20, wherein the filler(s), when present, is (are) chosen from the group composed of ceramic and/or mineral and/or metal fillers and/or silicas and/or diamond particles.

23. The coated cooking element according to claim 20, wherein the thermoplastic polymer(s), when present, is (are) chosen from the group composed of polyethersulfone (PES), polyphenylene sulfide (PPS), polyphenylene ether sulfone (PPSU), polyamide-imide (PAI), polyimide (PI), poly(phenylene oxide) (PPO), poly(arylenesulfide) (PAS), polyetherimide (PEI), and polybenzimidazole (PBI), liquid crystal polymers (LCP), polyaryletherketone (PAEK) including polyetherketone (PEK), polyetheretherketone (PEEK), polyetherketoneketone (PEKK), polyetheretherketoneketone (PEEKK), polyetherketoneetherketoneketone (PEKEKK) and mixtures thereof.

24. The coated cooking element according to claim 20, wherein the coloring agent(s), when present, is (are) chosen from the group composed of thermochromic pigments, thermostable pigments, flakes, and mixtures thereof.

25. The coated cooking element according to claim 24, wherein the thermochromic pigment(s) is (are) chosen from the group composed of Bi₂O₃, Fe₂O₃, V₂O₅, WO₃, CeO₂, In₂O₃, Y_{1.84}Ca_{0.16}Ti_{1.84}V_{0.16}O_{1.84}, AgI, (Bi₁₋ₓAₓ) (V_{1-y}M_{y})O₄ where
x is equal to 0 or x is comprised between 0.001 and 0.999;
y is equal to 0 or is comprised between 0.001 to 0.999;
A and M are chosen from the group composed of nitrogen, phosphorus, an alkali metal, an alkaline earth metal, a transition metal, a poor metal, a metalloid or a lanthanide;
A and M are different from each other.

26. The coated cooking element according to claim 24, wherein the thermostable pigment(s) is (are) chosen from the group composed of:
Yellow pigment of the rutile titanium type;
Yellow pigment derived from bismuth, for example selected from stabilized bismuth vanadates (Py₁₈₄);
Red pigment, for example selected from perylene red (for example, PR149, PR178 and PR224), iron oxide;
Orange pigment of the bismuth oxyhalides type (PO₈₅);
Bismuth vanadate orange pigment (PO₈₆);
Zinc tin titanium orange pigment (PO₈₂);
Cerium sulfide orange pigment (PO₇₅; PO₇₈);
Antimony titanium chromium orange-yellow pigment of the rutile type (PBr₂₄);
Tin and zinc orange yellow pigment of the rutile type (Py₂₁₆);
Orange-yellow niobium oxide sulfide tin zinc pigment (Py₂₂₇);
Double tin and niobium oxide orange yellow pigment;
Co₃ (PO₄)₂
LiCoPO₄;
CoAl₂O₄;
Cr₂O₃;
TiO₂;
Black pigment PBk28 (copper chromite black spinel);
and mixtures thereof.

27. The coated cooking element according to claim 24, wherein the flakes are holographic flakes that are a mixture of magnetizable particles and non-magnetizable particles.

28. The coated cooking element according to claim 20, wherein said metal substrate is an aluminum, stainless steel, cast iron or cast aluminum, iron, titanium or copper substrate.

29. The coated cooking element according to claim 20, wherein:
the thickness of the base layer is comprised between 5 μm and 100 μm; and
the thickness of the intermediate layers is comprised between 1 μm and 100 μm;
the thickness of the finishing layer is comprised between 0.05 μm and 100 μm.

30. The coated cooking element according to claim 29, wherein the thickness of the base layer is comprised between 20 μm and 70 μm.

31. The coated cooking element according to claim 29, wherein the thickness of the intermediate layer is comprised between 2 μm and 30 μm.

32. The coated cooking element according to claim 29, wherein the thickness of the finishing layer is comprised between 0.08 μm and 20 μm.

33. The coated cooking element according to claim 20, wherein the base layer is obtained from a sol-gel composition (SG) comprising at least one metal oxide, preferably a colloidal metal oxide chosen from colloidal silica and/or colloidal alumina and at least one precursor of metal alkoxide type, preferably an alkoxysilane chosen from the group composed of methyltrimethoxysilane (MTMS), tetraethoxysilane (TEOS), methyltriethoxysilane (MTES), dimethyldimethoxysilane, and mixtures thereof.

34. The coated cooking element according to claim 20, wherein the proportion of fillers in the intermediate and finishing layers, when present, is less than 10% by weight with regard to the total weight, respectively, of the intermediate layer, of the finishing layer.

35. The coated cooking element according to claim 20, wherein the proportion of additives in the intermediate and finishing layers, when present, is less than 20% by weight, with regard to the total weight of the intermediate layer, of the finishing layer.

36. A method of manufacturing a coated cooking element according to claim 20 comprising the following successive steps:
i. supplying a metal substrate comprising at least one face to be coated;
ii. optionally, pre-treating the face of said metal substrate intended to be coated;
iii. applying a sol-gel base layer on the face to be coated;
iv. optionally drying and/or curing of the base layer;
v. applying at least one intermediate layer;
vi. optionally, drying of the intermediate layer(s);
vii. applying at least one finishing layer; and
viii. curing of all base, intermediate and finishing layers.

37. A culinary item comprising a coated cooking element according to claim 20.

38. The culinary item according to claim 37, further comprising a heating face intended to be brought into contact with an external heating source, the heating face being opposite the cooking face intended to be brought into contact with the food during cooking.

39. The culinary item according to claim 38 chosen from the group composed of saucepan, frying pan, skillet, fondue pot or raclette, Dutch oven, wok, sauté pan, crepe maker, grill, griddle, marmite, cocotte, cooker or bread maker insert, culinary mold.

40. An electric cooking appliance having a coated cooking element and a heating source configured to heat said coated cooking element, wherein said coated cooking element is according to claim 20.

41. The electric cooking appliance according to claim 40, chosen from the group composed of electric crepe maker, electric raclette appliance, electric fondue appliance, electric grill, electric griddle, electric cooker, bread maker, electric pressure cooker, waffle makers, rice cookers and jam makers.
